(19) United States
(12) Patent Application Publication
(10) Pub. No.: US 2026/0320532 A1
(43) Pub. Date: Oct. 15, 2026

(54) ARTIFICIAL INTELLIGENCE-BASED VIRTUAL ENVIRONMENT ADAPTED FOR DISABILITIES AND LEARNING STYLES

(71) Applicant: U STARTUPS INC., Bethesda, MD (US)

(72) Inventors: John JABARA, Bethesda, MD (US); Khuram ZAMAN, Bethesda, MD (US); Marc STEREN, Bethesda, MD (US)

(73) Assignee: U STARTUPS INC., Bethesda, MD (US)

(21) Appl. No.: 19/465,147

(22) Filed: Jan. 30, 2026

Related U.S. Application Data
(60) Provisional application No. 63/752,147, filed on Jan. 31, 2025.

(51) Int. Cl. G06Q 10/0639; G06N 3/045

(52) U.S. Cl. CPC G06Q 10/0639; G06N 3/045

(57) ABSTRACT

A computer-implemented virtual internship system provides a task-based environment that automatically adapts to disabilities and learning styles while generating transition-planning evidence. The system maintains an internal “skills lens” data structure representing multi-dimensional skills and references a “success matrix” mapping disability attributes and behavioral patterns to accommodations, coaching strategies, and success criteria. AI components generate personalized tasks, present a company-portal workspace, deliver real-time guidance via a transformer-based conversational interface, and assess performance relative to expectations and peer cohorts. The skills lens is updated based on task interactions and accessibility usage, and used to select subsequent coaching prompts and task adaptations. A reporting module produces framework-tagged documentation, aligned with IDEA transition domains and Perkins skills, suitable for inclusion in individualized education programs.

### CROSS-REFERENCE TO RELATED APPLICATION

This application claims priority to U.S. Provisional Application No. 63/752,147, filed Jan. 31, 2025, which is incorporated herein by reference in its entirety for all purposes.

### BACKGROUND

Virtual internship platforms and online work-based learning tools are increasingly used to expose students to professional environments, but most existing systems are designed around generic content delivery, project completion, and grade-based assessments. They typically do not maintain a structured, evolving representation of a learner's skills, nor do they align student activity with legal and regulatory frameworks such as the Individuals with Disabilities Education Act (IDEA) transition requirements. As a result, educators must manually interpret logs, assignments, and communications to extract evidence of skill development and transition readiness, a process that is labor-intensive, inconsistent, and prone to gaps in documentation.

These limitations are especially acute for students with disabilities. Conventional platforms generally do not operationalize disability-related information in a systematic way. Existing systems lack structured mappings from disability attributes or observed behaviors to specific task-level accommodations, workflow modifications, and success criteria, and they do not treat such mappings as a core driver of coaching, task design, or performance evaluation. Consequently, learners with disabilities often encounter the same tasks and guidance as their peers, with only superficial adjustments and without an integrated model that links supports to measurable skill growth.

### SUMMARY

For the aforementioned reasons, there is therefore a need for a virtual, task-based internship system that (i) maintains an internal skills lens—an evolving, multi-dimensional representation of employability skills updated based on user interactions and task performance; (ii) uses a success matrix that systematically translates disability attributes and behaviors into tailored accommodations, strategies, and success criteria; and (iii) automatically generates reports and evidence aligned to recognized transition and employability frameworks. Such a system should leverage artificial intelligence not merely to deliver content or immediate feedback, but to interpret actions, accessibility usage, and interactive behavior as signals of skill development, adapt future tasks and coaching based on the internal model, and reduce the administrative burden of producing compliance-ready documentation for students with disabilities.

Virtual learning platforms can deliver educational content remotely, enabling students to participate in structured activities without physical presence at a worksite. However, existing remote learning systems typically provide uniform task presentation and static instructional materials that do not adapt to individual learner needs. These conventional platforms lack mechanisms to automatically adjust task complexity, provide real-time personalized coaching, or generate documentation aligned with federal transition-planning requirements for students with disabilities.

Students with disabilities frequently encounter barriers when attempting to access traditional work-based learning programs, including geographic limitations, scheduling conflicts, and the need for individualized accommodations that exceed available administrative resources. Conventional virtual learning platforms deliver static educational content through uniform interfaces that do not adjust to diverse learner needs, requiring manual intervention by educators to modify task complexity or presentation format for each student. Remote learning systems typically lack real-time mechanisms to detect when a student with a specific disability requires additional support, instead relying on post-hoc assessments or periodic check-ins to identify skill gaps or engagement issues. Existing platforms also fail to generate documentation that satisfies federal transition-planning requirements under the Individuals with Disabilities Education Act (IDEA), such as evidence of skill development aligned with employability frameworks or post-secondary readiness indicators, thereby imposing additional reporting burdens on special education staff.

The techniques described herein can provide a computer-implemented virtual task-based environment that automatically adapts task presentation, coaching interactions, and performance documentation to the specific disability or learning style of each user. By maintaining an internal skill representation in a data structure referred to as a skills lens, the system can map user behaviors and task performance to multiple employability skill dimensions, such as communication, problem-solving, and technology use, among others. The system can reference a success matrix that associates disability-related attributes or observed behaviors with corresponding accommodation strategies, task-level supports, and success criteria for one or more employability skill dimensions. Based on the updated skills lens and the success matrix, the system can select personalized coaching prompts or accommodation recommendations for subsequent tasks, thereby enabling real-time adaptive support without manual educator intervention. The system can generate reports that include employability skill indicators derived from the skills lens and at least one accommodation or strategy derived from the success matrix, such that the documentation satisfies legal compliance requirements for transition planning while reducing administrative workload for educators.

The methods and systems discussed herein provide a virtual, task-based internship environment that is specifically configured to support students with disabilities while generating structured, compliance-ready evidence of employability skill development. In one aspect, the methods and systems implement an internal “skills lens” data structure that maintains an evolving, multi-dimensional representation of a user's employability skills. User interactions within the simulated workplace—including initiation and completion of tasks, exchanges with an AI supervisor, and use of accessibility features—are interpreted and mapped into one or more recognized employability skill dimensions, enabling real-time tracking of growth and gaps across a plurality of skills.

In another aspect, the methods and systems employ a “success matrix” that associates disability attributes or observed behaviors with corresponding accommodations, task-level supports, and success criteria. The success matrix is used in conjunction with the skills lens to automatically select and apply tailored strategies for individual users, such that the same underlying task can be adapted with different instructions, supports, or pacing based on a user's disability or learning style. This allows an AI-based interactive component to act as a supervisor or mentor that delivers personalized coaching prompts and micro-scaffolding grounded in both disability-aware design and employability skill targets.

In a further aspect, the methods and systems automatically generate reports and artifacts that align user activity with external frameworks such as IDEA transition domains and Perkins employability skills categories. By combining the skills lens and success matrix with performance comparisons to expectations and peer cohorts, the system produces dynamic, legally meaningful documentation of work-based learning, including transition-planning evidence and skill-gap analyses. This integration reduces manual reporting burdens on educators and administrators while providing students with disabilities a highly supported, accessible, and professionally framed internship simulation that builds workplace readiness and AI literacy.

In some aspects, the techniques described herein relate to a computer-implemented method for presenting a virtual task-based environment for a user, the method including: receiving, by at least one processor, background information about a user having a disability or learning style; maintaining, by the at least one processor, an internal attribute representation for the user in a data structure configured to map user behaviors and task performance to a plurality of skill dimensions; mapping, by the at least one processor, a success matrix including mappings from disability-related attributes or observed behaviors to corresponding accommodation strategies, task-level supports, and success criteria for one or more of the plurality of skill dimensions; generating, by the at least one processor using a machine learning model, at least one task based on the background information about the user, wherein the at least one task is configured for completion in the virtual task-based environment by the user based in-part on a disability or learning style of the user; presenting, by the at least one processor, a virtual workspace configured to simulate a work environment by containing the at least one task for completion and containing buttons configured to receive an input from the user; executing, by the at least one processor using at least one input associated with the at least one task, an artificial intelligence-based interactive component including a transformer model trained on internship data and a plurality of disabilities and learning styles to generate and display a natural-language guidance message including at least one of task customized based on the disability or learning style of the user; responsive to initiation or completion of at least one task presented on the virtual workspace, executing, by the at least one processor, an artificial intelligence model receiving information about the initiation or completion of the task including at least one of a task initiation time, a task completion time, or a task submission status, and to compare the information to an expectation and other users to predict performance assessment data; updating, by the at least one processor, the data structure based on the information about the initiation or completion of the at least one task, including assigning one or more scores or indicators for skills associated with the at least one task; selecting, by the at least one processor based on the updated data structure, the success matrix, and the performance assessment data, one or more personalized coaching prompts or accommodation recommendations for the user for subsequent tasks in the virtual task-based environment; and generating and transmitting, by the at least one processor, a report of the initiation or completion of the at least one task to a remote computer, wherein the report dynamically adjusts to performance trends of other users and further includes one or more skill indicators derived from the data structure and at least one accommodation or strategy derived from the success matrix.

In some aspects, the techniques described herein relate to a computer-implemented method, wherein the data structure includes a multi-dimensional vector representation of the user's skills, each dimension corresponding to at least one of applied academic skills, critical thinking skills, interpersonal skills, personal qualities, resource management, information use, communication skills, systems thinking, or technology use.

In some aspects, the techniques described herein relate to a computer-implemented method, wherein updating the data structure includes mapping individual user interactions within the virtual workspace to one or more skill dimensions using a predefined ruleset or machine-learned model.

In some aspects, the techniques described herein relate to a computer-implemented method, wherein the success matrix includes a plurality of entries, each entry associating at least one of a disability label or pattern of observed behaviors with at least one of task-level accommodations, workflow modifications, coaching strategies or corresponding success criteria for at least one skill dimension.

In some aspects, the techniques described herein relate to a computer-implemented method, wherein selecting one or more personalized coaching prompts based on the updated data structure and the success matrix includes identifying at least one skill dimension below a proficiency threshold.

In some aspects, the techniques described herein relate to a computer-implemented method, wherein the report further includes legally compliant transition-planning evidence by tagging skill indicators with at least one of an Individuals with Disabilities Education Act (IDEA) transition domain and a Perkins skills framework category.

In some aspects, the techniques described herein relate to a computer-implemented method, wherein generating at least one task further includes modifying task parameters based on the success matrix to incorporate one or more accommodations selected for the user, including at least one of extended time, altered presentation modality, simplified instructions, or assistive technology prompts.

In some aspects, the techniques described herein relate to a system for presenting a virtual task-based environment for a user, the system including at least one processor configured to: receive background information about a user having a disability or learning style; maintain an internal attribute representation for the user in a data structure configured to map user behaviors and task performance to a plurality of skill dimensions; map a success matrix including mappings from disability-related attributes or observed behaviors to corresponding accommodation strategies, task-level supports, and success criteria for one or more of the plurality of skill dimensions; generate, using a machine learning model, at least one task based on the background information about the user, wherein the at least one task is configured for completion in the virtual task-based environment by the user based in-part on a disability or learning style of the user; present a virtual workspace configured to simulate a work environment by containing the at least one task for completion and containing buttons configured to receive an input from the user; execute, using at least one input associated with the at least one task, an artificial intelligence-based interactive component including a transformer model trained on internship data and a plurality of disabilities and learning styles to generate and display a natural-language guidance message including at least one of task customized based on the disability or learning style of the user; responsive to initiation or completion of at least one task presented on the virtual workspace, execute an artificial intelligence model receiving information about the initiation or completion of the task including at least one of a task initiation time, a task completion time, or a task submission status, and to compare the information to an expectation and other users to predict performance assessment data; update the data structure based on the information about the initiation or completion of the at least one task, including assigning one or more scores or indicators for skills associated with the at least one task; select, based on the updated data structure, the success matrix, and the performance assessment data, one or more personalized coaching prompts or accommodation recommendations for the user for subsequent tasks in the virtual task-based environment; and generate and transmit a report of the initiation or completion of the at least one task to a remote computer, wherein the report dynamically adjusts to performance trends of other users and further includes one or more skill indicators derived from the data structure and at least one accommodation or strategy derived from the success matrix.

In some aspects, the techniques described herein relate to a system, wherein the data structure includes a multi-dimensional vector representation of the user's skills, each dimension corresponding to at least one of applied academic skills, critical thinking skills, interpersonal skills, personal qualities, resource management, information use, communication skills, systems thinking, or technology use.

In some aspects, the techniques described herein relate to a system, wherein updating the data structure includes mapping individual user interactions within the virtual workspace to one or more skill dimensions using a predefined ruleset or machine-learned model.

In some aspects, the techniques described herein relate to a system, wherein the success matrix includes a plurality of entries, each entry associating at least one of a disability label or pattern of observed behaviors with at least one of task-level accommodations, workflow modifications, coaching strategies or corresponding success criteria for at least one skill dimension.

In some aspects, the techniques described herein relate to a system, wherein selecting one or more personalized coaching prompts based on the updated data structure and the success matrix includes identifying at least one skill dimension below a proficiency threshold.

In some aspects, the techniques described herein relate to a system, wherein the report further includes legally compliant transition-planning evidence by tagging skill indicators with at least one of an Individuals with Disabilities Education Act (IDEA) transition domain and a Perkins skills framework category.

In some aspects, the techniques described herein relate to a system, wherein generating at least one task further includes modifying task parameters based on the success matrix to incorporate one or more accommodations selected for the user, including at least one of extended time, altered presentation modality, simplified instructions, or assistive technology prompts.

In some aspects, the techniques described herein relate to a system for presenting a virtual task-based environment for a user, the system including a non-transitory computer readable medium having at least one instructions that when executed causes at least one processor to: receive background information about a user having a disability or learning style; maintain an internal attribute representation for the user in a data structure configured to map user behaviors and task performance to a plurality of skill dimensions; map a success matrix including mappings from disability-related attributes or observed behaviors to corresponding accommodation strategies, task-level supports, and success criteria for one or more of the plurality of skill dimensions; generate, using a machine learning model, at least one task based on the background information about the user, wherein the at least one task is configured for completion in the virtual task-based environment by the user based in-part on a disability or learning style of the user; present a virtual workspace configured to simulate a work environment by containing the at least one task for completion and containing buttons configured to receive an input from the user; execute, using at least one input associated with the at least one task, an artificial intelligence-based interactive component including a transformer model trained on internship data and a plurality of disabilities and learning styles to generate and display a natural-language guidance message including at least one of task customized based on the disability or learning style of the user; responsive to initiation or completion of at least one task presented on the virtual workspace, execute an artificial intelligence model receiving information about the initiation or completion of the task including at least one of a task initiation time, a task completion time, or a task submission status, and to compare the information to an expectation and other users to predict performance assessment data; update the data structure based on the information about the initiation or completion of the at least one task, including assigning one or more scores or indicators for skills associated with the at least one task; select, based on the updated data structure, the success matrix, and the performance assessment data, one or more personalized coaching prompts or accommodation recommendations for the user for subsequent tasks in the virtual task-based environment; and generate and transmit a report of the initiation or completion of the at least one task to a remote computer, wherein the report dynamically adjusts to performance trends of other users and further includes one or more skill indicators derived from the data structure and at least one accommodation or strategy derived from the success matrix.

In some aspects, the techniques described herein relate to a system, wherein the data structure includes a multi-dimensional vector representation of the user's skills, each dimension corresponding to at least one of applied academic skills, critical thinking skills, interpersonal skills, personal qualities, resource management, information use, communication skills, systems thinking, or technology use.

In some aspects, the techniques described herein relate to a system, wherein updating the data structure includes mapping individual user interactions within the virtual workspace to one or more skill dimensions using a predefined ruleset or machine-learned model.

In some aspects, the techniques described herein relate to a system, wherein the success matrix includes a plurality of entries, each entry associating at least one of a disability label or pattern of observed behaviors with at least one of task-level accommodations, workflow modifications, coaching strategies or corresponding success criteria for at least one skill dimension.

In some aspects, the techniques described herein relate to a system, wherein selecting one or more personalized coaching prompts based on the updated data structure and the success matrix includes identifying at least one skill dimension below a proficiency threshold.

In some aspects, the techniques described herein relate to a system, wherein the report further includes legally compliant transition-planning evidence by tagging skill indicators with at least one of an Individuals with Disabilities Education Act (IDEA) transition domain and a Perkins skills framework category.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 illustrates a block diagram for an AI-enabled internship system, in accordance with embodiments.

FIGS. 2A-2B illustrate a flowchart for an example process for generating and presenting a virtual task-based workspace and executing an AI-based interactive component based on user background information, in accordance with embodiments.

FIG. 3 illustrate a component diagram of a computing system suitable for use in the various implementations described herein, in accordance with embodiments.

### DETAILED DESCRIPTION

Below are detailed descriptions of various concepts related to, and approaches, methods, apparatuses, and systems for implementing the various techniques described herein. The various concepts introduced above and discussed in greater detail below may be implemented in any of numerous ways, as the described concepts are not limited to any particular manner of implementation. Examples of specific implementations and applications are provided primarily for illustrative purposes.

Students with disabilities frequently encounter barriers when attempting to access traditional work-based learning programs, including geographic limitations, scheduling conflicts, and the need for individualized accommodations that exceed available administrative resources. Conventional virtual learning platforms deliver static educational content through uniform interfaces that do not adjust to diverse learner needs, requiring manual intervention by educators to modify task complexity or presentation format for each student. Remote learning systems typically lack real-time mechanisms to detect when a student with a specific disability requires additional support, instead relying on post-hoc assessments or periodic check-ins to identify skill gaps or engagement issues. Existing platforms also fail to generate documentation that satisfies federal transition-planning requirements under the Individuals with Disabilities Education Act (IDEA), such as evidence of skill development aligned with employability frameworks or post-secondary readiness indicators, thereby imposing additional reporting burdens on special education staff.

The techniques described herein can provide a computer-implemented virtual task-based environment that automatically adapts task presentation, coaching interactions, and performance documentation to the specific disability or learning style of each user. By maintaining an internal skill representation in a data structure referred to as a skills lens, the system can map user behaviors and task performance to multiple employability skill dimensions, such as communication, problem-solving, and technology use, among others. The system can reference a success matrix that associates disability-related attributes or observed behaviors with corresponding accommodation strategies, task-level supports, and success criteria for one or more employability skill dimensions. Based on the updated skills lens and the success matrix, the system can select personalized coaching prompts or accommodation recommendations for subsequent tasks, thereby providing real-time adaptive support without manual educator intervention. The system can generate reports that include employability skill indicators derived from the skills lens and at least one accommodation or strategy derived from the success matrix, such that the documentation satisfies legal compliance requirements for transition planning while reducing administrative workload for educators.

To implement the techniques described herein, the system can receive background information about a user, including information about a disability or learning style. The system can maintain an internal skill representation for the user in a skills lens data structure. The skills lens data structure can be configured to map user behaviors and task performance to a plurality of employability skill dimensions. The system can reference a success matrix comprising mappings from disability-related attributes or observed behaviors to corresponding accommodation strategies, task-level supports, and success criteria for one or more of the employability skill dimensions. The system can generate, using a machine learning model trained on industry-specific frameworks, at least one task based on the background information about the user. The at least one task can be configured for completion in the virtual task-based environment by the user based in part on a disability or learning style of the user.

The system can present a virtual workspace configured to simulate a work environment by containing the at least one task for completion and containing buttons configured to receive an input from the user. The system can execute an artificial intelligence-based interactive component comprising a transformer model trained on internship data and a plurality of disabilities and learning styles. Responsive to initiation or completion of at least one task presented on the virtual workspace, the system can execute an artificial intelligence model receiving information about the initiation or completion of the task and compare performance to an expectation and other users. The system can update the skills lens based on the information about the initiation or completion of the at least one task, including assigning one or more scores or indicators for employability skills associated with the at least one task. The system can select, based on the updated skills lens and the success matrix, one or more personalized coaching prompts or accommodation recommendations for the user for subsequent tasks in the virtual task-based environment. The system can generate and transmit a report of the initiation or completion of the at least one task to a remote computer. The report can dynamically adjust to performance trends of other users and can further include one or more employability skill indicators derived from the skills lens and at least one accommodation or strategy derived from the success matrix.

The techniques described herein can address the problems identified above by automatically adapting task presentation and coaching interactions to the specific needs of users with disabilities, eliminating the need for manual intervention by educators to modify task complexity or presentation format. By maintaining a skills lens that maps user behaviors and task performance to employability skill dimensions in real time, the system can detect when a student requires additional support and can immediately select personalized coaching prompts or accommodation recommendations based on the success matrix, such that skill gaps and engagement issues can be addressed as the user completes tasks. The system can generate reports that include employability skill indicators derived from the skills lens and accommodations or strategies derived from the success matrix, such that the documentation satisfies federal transition-planning requirements under IDEA without imposing additional reporting burdens on special education staff. The techniques described herein can provide a technical improvement over existing approaches by automating the adaptation of virtual learning environments to diverse learner needs, reducing administrative workload, and generating legally compliant documentation for transition planning.

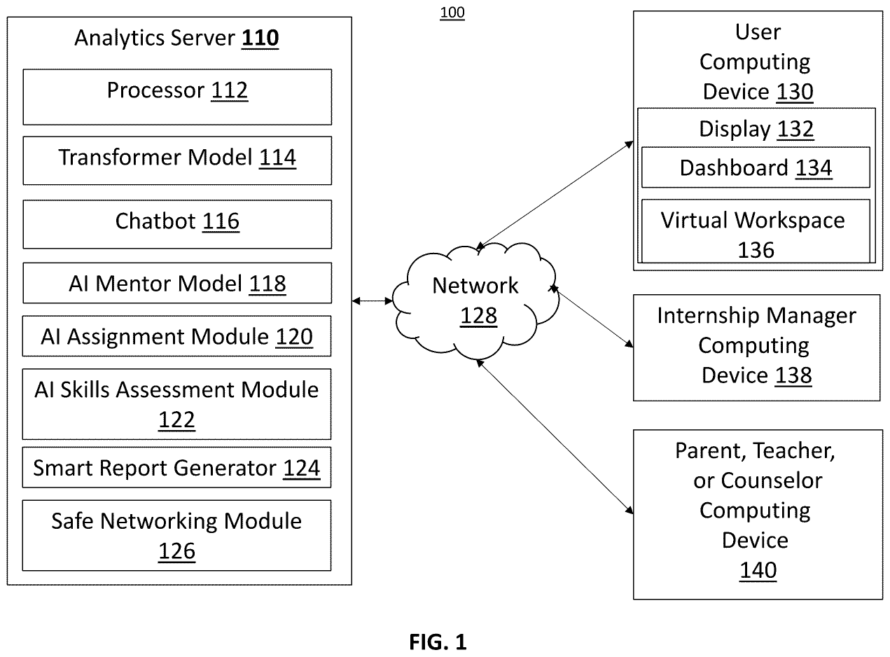

Referring now to FIG. 1, illustrated is an AI-enabled internship system 100 that includes a block diagram of an analytics server 110 in communication with multiple client computing devices over a network 128. The analytics server 110 can include a processor 112, a transformer model 114, a chatbot 116, an AI mentor model 118, an AI assignment module 120, an AI skills assessment module 122, a smart report generator 124, and a safe networking module 126. The system can further include one or more user computing device 130, one or more internship manager computing device 138, and one or more parent, teacher, or counselor computing device 140. The user computing device 130 can include a display 132, a dashboard 134, and a virtual workspace 136.

The analytics server 110 can include at least the processor 112. The processor 112 can be any type of computing processor including one or more central processing units, graphical processing units, tensor processing units, or any combination thereof. For example, the processor 112 can include multi-core processors, distributed processors across cloud infrastructure, or application-specific integrated circuits arranged to execute machine learning operations. The processor 112 can execute instructions to receive background information about a user having a disability or learning style, maintain an internal skill representation for the user in a skills lens data structure, and generate at least one task using a machine learning model trained on industry-specific frameworks.

In some implementations, the processor 112 can execute instructions to present a virtual workspace 136 on the user computing device 130 via the network 128, whereby the virtual workspace 136 simulates a work environment containing tasks and interactive elements. The processor 112 may access non-transitory computer-readable memory storing instructions for implementing adaptive task generation, real-time skills assessment, and personalized coaching interactions. The instructions may include, but are not limited to, instructions to execute the transformer model 114, operate the chatbot 116, invoke the AI mentor model 118, generate assignments via the AI assignment module 120, assess skills via the AI skills assessment module 122, produce reports via the smart report generator 124, and facilitate communications via the safe networking module 126.

The analytics server 110 can include a transformer model 114. The transformer model 114 can be a neural network architecture that processes sequential data through self-attention mechanisms, enabling the analytics server 110 to analyze natural language inputs received from users engaging with the virtual task-based environment. For example, the transformer model 114 may be implemented as a large language model or similar architectures that have been trained on diverse text corpora including internship data, workplace communication models, mentorship scripts, and disability accommodation strategies. The transformer model 114 can process user inquiries, task-related questions, and conversational inputs to generate responses that account for the user's disability or learning style as recorded in the background information received during onboarding.

In some implementations, the transformer model 114 can receive input sequences from the chatbot 116, tokenize the input text into discrete units, apply multi-head attention layers to compute relationships among tokens across the sequence, and produce output sequences that form natural language guidance for presentation to the user via the user computing device 130. The tokenization operation may convert each word or sub-word in the input sequence into a numerical representation, such as a vector embedding, which is subsequently processed by the multi-head attention layers to identify contextual dependencies between tokens regardless of their positional distance in the sequence. The multi-head attention layers may compute attention scores that quantify the relevance of each token to every other token in the sequence, such that the transformer model 114 can generate contextually appropriate responses even when the user's query contains ambiguous phrasing or incomplete information.

The transformer model 114 can generate responses tailored to specific disabilities by referencing the success matrix to retrieve accommodation strategies and coaching prompts mapped to disability-related attributes, such that guidance provided to the user aligns with individualized support needs. For example, when the transformer model 114 receives an input sequence indicating that a user with dyslexia is requesting assistance with a reading-intensive task, the transformer model 114 may query the success matrix to retrieve entries specifying accommodations such as text simplification, audio narration, or structured step-by-step instructions, and may incorporate those accommodations into the generated output sequence. In some implementations, the transformer model 114 can apply a conditioning mechanism during the generation process that biases the probability distribution over output tokens toward vocabulary and sentence structures consistent with the user's disability or learning style, such that the generated responses avoid complex terminology or lengthy explanations when the success matrix indicates that such content may be difficult for the user to process.

The conditioning mechanism may involve modifying the attention weights computed by the multi-head attention layers based on parameters retrieved from the success matrix, such as preferred vocabulary complexity levels or maximum sentence lengths, such that the transformer model 114 produces responses that satisfy both the semantic requirements of the user's query and the accessibility requirements specified in the success matrix. The transformer model 114 may also incorporate feedback signals from the AI skills assessment module 122 to adjust the complexity or pacing of generated responses based on the user's current proficiency levels in one or more employability skill dimensions, such that the transformer model 114 provides more detailed explanations when the skills lens data structure indicates that the user is struggling with a particular skill or provides more concise guidance when the user demonstrates proficiency.

The output sequences generated by the transformer model 114 may include step-by-step instructions for completing a task, explanations of task requirements, troubleshooting suggestions when the user encounters difficulty, or encouragement messages that adapt dynamically based on the user's progress through the virtual workspace 136 and engagement patterns detected by the AI skills assessment module 122. For example, if the transformer model 114 receives an input sequence indicating that the user has submitted a task with errors and the AI skills assessment module 122 has determined that the user's performance on communication skills is below a proficiency threshold, the transformer model 114 may generate an output sequence that provides targeted feedback on the specific communication deficiencies observed in the task submission, such as explaining how to structure a professional email or how to phrase a customer inquiry, and may include a suggestion to review a just-in-time lesson on business communication practices.

In some implementations, the transformer model 114 can generate encouragement messages that are dynamically adjusted based on the user's recent engagement patterns, such as increasing the frequency of positive reinforcement messages when the analytics server 110 detects that the user has missed multiple deadlines or demonstrated reduced engagement with the virtual workspace 136, or providing more challenging follow-up questions when the user consistently completes tasks ahead of schedule with high proficiency scores.

The transformer model 114 may also generate output sequences that explain to the user, in simplified language, how specific recommended accommodations or strategies from the success matrix are intended to support successful completion of a task, such that the user understands the rationale for applying text-to-speech functionality or extended time accommodations and can make informed decisions about which accommodations to utilize during subsequent tasks. The analytics server 110 may transmit the output sequences generated by the transformer model 114 to the user computing device 130 via the network 128 for presentation within the virtual workspace 136, such that the user receives real-time personalized coaching without requiring manual intervention by educators or facilitators.

The analytics server 110 can include a chatbot 116. The chatbot 116 can be a conversational interface that interacts with users through natural language inputs and outputs, facilitating real-time communication between the user and the virtual internship environment. For example, the chatbot 116 can present itself as a virtual mentor or advisor within the virtual workspace 136, appearing in a chat window or side panel where users can type questions or receive automated prompts. The chatbot 116 can engage in conversation with users to provide guidance, feedback, troubleshooting, and assessment as the users complete project assignments within the virtual workspace 136. In some implementations, the chatbot 116 can proactively initiate conversations based on specific triggers, such as a user missing a deadline, making repeated mistakes in task completion, or explicitly requesting assistance via a help button in the virtual workspace 136.

The chatbot 116 may transmit user inputs to the transformer model 114 for processing and receive generated responses from the transformer model 114, which the chatbot 116 then presents to the user in natural language format. For example, when a user types a question about how to complete a professional email task, the chatbot 116 may send the query text to the transformer model 114, which tokenizes the input, applies attention mechanisms to generate a contextually appropriate response, and returns the response to the chatbot 116 for display within the virtual workspace 136.

The chatbot 116 can adapt responses dynamically based on the user's disability or learning style by retrieving accommodation strategies from the success matrix. In some implementations, the chatbot 116 can query the success matrix using the user's disability-related attributes or observed behavior patterns to obtain task-level supports, such as breaking explanations into smaller sub-steps for users with autism spectrum disorder or providing audio descriptions for users with low vision. For example, when a user with dyslexia requests help with a reading-intensive task, the chatbot 116 may retrieve an entry from the success matrix specifying accommodations such as text simplification and audio narration, and may incorporate those accommodations into the generated response by rewriting complex sentences into shorter, simpler structures and offering an audio playback option.

The chatbot 116 may also access the skills lens data structure to retrieve current employability skill scores for the user and tailor the complexity or pacing of responses based on proficiency levels in one or more skill dimensions. For example, if the skills lens indicates that the user's communication skills are below a proficiency threshold, the chatbot 116 may provide more detailed explanations of professional communication standards, such as explaining how to structure a formal email or how to phrase a customer inquiry, whereas if the user demonstrates proficiency, the chatbot 116 may provide more concise guidance. The chatbot 116 may present responses within the virtual workspace 136 via a persistent chat interface that allows the user to scroll through previous messages, review guidance provided earlier, and continue conversations across multiple sessions without losing context.

The analytics server 110 can include an AI mentor model 118. The AI mentor model 118 can be a machine learning model trained to simulate mentorship interactions by providing personalized coaching, feedback, and support to users based on their performance, disability, and learning style. For example, the AI mentor model 118 can be trained using supervised learning on datasets that include industry best practices, workplace communication models, previous internship data, and mentorship scripts designed to provide appropriate feedback for students with disabilities. The AI mentor model 118 can select personalized coaching prompts or accommodation recommendations for the user for subsequent tasks in the virtual task-based environment based on the updated skills lens and the success matrix.

In some implementations, the AI mentor model 118 can identify at least one employability skill dimension below a proficiency threshold and apply a corresponding success matrix entry to generate targeted coaching instructions specific to the user's disability or learning style. For example, when the AI mentor model 118 retrieves the skills lens data structure for a user and determines that the communication skills dimension has a score of 3.2 out of 10, which falls below a predefined proficiency threshold of 5.0, the AI mentor model 118 may query the success matrix using the user's disability label (such as attention deficit hyperactivity disorder, or ADHD) to retrieve a coaching strategy specifying that the user should receive short, structured prompts emphasizing one communication principle at a time, along with an accommodation strategy recommending visual checklists for drafting professional emails. The AI mentor model 118 may access the skills lens data structure to retrieve current scores or indicators for employability skills associated with completed tasks, compare those scores to predefined proficiency thresholds, and determine which skill dimensions require additional support.

In some implementations, the AI mentor model 118 may retrieve proficiency thresholds stored in a configuration file or database that specify minimum acceptable scores for each employability skill dimension, such as a threshold of 6.0 for critical thinking skills or a threshold of 5.5 for interpersonal skills, and may flag dimensions falling below those thresholds for targeted coaching intervention. The AI mentor model 118 may then query the success matrix using the user's disability label or observed behavior patterns to retrieve one or more task-level accommodations, workflow modifications, or coaching strategies, which are presented to the user via the chatbot 116. For example, when the AI mentor model 118 retrieves an entry from the success matrix associating dyslexia with accommodations such as text simplification, audio narration, and extended time for reading-intensive tasks, the AI mentor model 118 may generate a coaching message transmitted to the chatbot 116 that explains to the user how enabling the text-to-speech feature can reduce cognitive load during email composition and suggests reviewing a short instructional video on structuring professional correspondence before attempting the next task.

The analytics server 110 can include an AI assignment module 120. The AI assignment module 120 can be a software component that generates task-based projects dynamically using machine learning models trained on industry-specific frameworks and employability skill models. For example, the AI assignment module 120 can generate assignments such as brainstorming names for a new course, creating promotional flyers, developing social media marketing strategies, presenting ideas effectively, or testing interactive career pathways tools, all tailored to simulate real-world work experiences. The AI assignment module 120 can generate at least one task based on the background information about the user, wherein the at least one task may be configured for completion in the virtual task-based environment by the user based in part on a disability or learning style of the user.

In some implementations, the AI assignment module 120 can modify task parameters based on the success matrix to incorporate one or more accommodations selected for the user, including at least one of extended time, altered presentation modality, simplified instructions, or assistive technology prompts. For example, when the success matrix indicates that a user with dyslexia benefits from simplified instructions, the AI assignment module 120 may rewrite task descriptions to use shorter sentences, reduce vocabulary complexity to an eighth-grade reading level, and include step-by-step bullet points that break a multi-part assignment into discrete subtasks, such that each sub-task requires no more than three actions. The AI assignment module 120 may query the success matrix using the user's disability-related attributes or observed behaviors to access corresponding task-level supports, such as breaking tasks into smaller sub-tasks for users with autism spectrum disorder or providing audio descriptions for users with low vision.

In some implementations, the AI assignment module 120 may access the skills lens data structure to retrieve current employability skill scores for the user and adjust task difficulty based on proficiency levels in one or more skill dimensions, such that users demonstrating lower proficiency in communication skills receive tasks with reduced complexity in writing requirements, whereas users with higher proficiency receive tasks involving multi-stakeholder communication scenarios. The AI assignment module 120 may transmit the generated tasks to the user computing device 130 for presentation within the virtual workspace 136, where the user can view task descriptions, access relevant materials, and submit completed work.

The analytics server 110 can include an AI skills assessment module 122. The AI skills assessment module 122 can be a machine learning component that evaluates the performance of users as the users complete assigned tasks by comparing responses to predefined criteria, organizational benchmarks, and the performance of similar users. For example, the AI skills assessment module 122 can analyze task submissions to identify patterns of errors, such as repeated formatting mistakes in professional emails or consistent delays in responding to customer inquiries, measure success rates by computing the percentage of tasks completed without requiring remedial coaching interventions, track time taken for task completion by recording timestamps at task initiation and submission events, and determine relative proficiency in multiple employability skill dimensions such as communication, problem-solving, or technology use.

The AI skills assessment module 122 can execute an artificial intelligence model receiving information about the initiation or completion of a task and compare performance to an expectation and other users. In some implementations, the AI skills assessment module 122 can determine a relative proficiency score for at least one employability skill dimension by comparing the user's skills lens values to aggregate skills lens values for a cohort of users performing similar tasks. For example, when the AI skills assessment module 122 retrieves a communication skills score of 5.8 from the skills lens data structure for a user who has completed a professional email drafting task, the AI skills assessment module 122 may access a database of aggregate performance data for other users with similar disabilities or backgrounds who have completed the same task, compute a percentile ranking by determining that the user's score exceeds 62% of the cohort, and assign a deviation score by calculating the number of standard deviations by which the user's score differs from the cohort mean.

The AI skills assessment module 122 may access the skills lens data structure to retrieve current employability skill indicators for the user, access a database of aggregate performance data for other users with similar disabilities or backgrounds, and compute percentile rankings or deviation scores that indicate the user's standing relative to peers. The AI skills assessment module 122 may transmit assessment results to the smart report generator 124, which incorporates the results into reports delivered to stakeholders such as educators, parents, or internship facilitators.

The analytics server 110 can include a smart report generator 124. The smart report generator 124 can be a software component that compiles and delivers dynamic reports to stakeholders by synthesizing real-time performance data, task completion metrics, and personalized recommendations derived from the skills lens data structure and the success matrix. For example, the smart report generator 124 can generate reports that summarize the user's progress with tasks completed, tasks missing, and tasks to be done, while also highlighting strengths and development areas demonstrated during the internship based on employability skill indicators stored in the skills lens.

The smart report generator 124 can generate and transmit a report of the initiation or completion of the at least one task to a remote computer, wherein the report dynamically adjusts to performance trends of other users and further comprises one or more employability skill indicators derived from the skills lens and at least one accommodation or strategy derived from the success matrix. In some implementations, the smart report generator 124 can produce legally compliant transition-planning evidence by tagging employability skill indicators with at least one of an Individuals with Disabilities Education Act transition domain and a Perkins employability skills framework category. For example, the smart report generator 124 may tag a communication skills indicator associated with a professional email drafting task with an IDEA Employment transition domain and a Perkins Communication Skills category, such that the report satisfies federal documentation requirements for Individualized Education Programs without requiring manual annotation by educators.

The smart report generator 124 may retrieve data from the skills lens data structure to obtain employability skill scores, query the success matrix to identify accommodations or strategies applied during task completion, and access performance data for cohorts of similar users to compute benchmarking statistics. In some implementations, the smart report generator 124 may compute percentile rankings by comparing the user's employability skill scores to aggregate scores stored for other users with similar disability labels or learning styles who have completed the same tasks, such that the report indicates whether the user's performance exceeds 50%, 70%, or 90% of the cohort, among other percentile thresholds. The smart report generator 124 may transmit the generated reports to the internship manager computing device 138 and the parent, teacher, or counselor computing device 140 via the network 128, enabling stakeholders to monitor progress and provide additional support as needed.

In some implementations, the analytics server 110 can integrate with an external transition plan creator system configured to generate or update individualized transition plans, such as transition plans required under the IDEA. The transition plan creator system can receive, as input, employability skill indicators derived from the skills lens data structure, accommodations and strategies derived from the success matrix, and performance summaries generated by the smart report generator 124. The transition plan creator system can apply one or more rules or machine learning models to transform the received indicators and summaries into proposed transition goals, benchmarks, and services for inclusion in an individualized education program. For example, when the skills lens indicates that a user has achieved a communication skills score above a defined proficiency threshold while repeatedly utilizing text-to-speech and enlarged-font accommodations, the transition plan creator system may generate a proposed postsecondary employment goal describing the user's readiness for customer-facing roles, along with recommended accommodations to be communicated to prospective employers or postsecondary disability offices. By programmatically ingesting outputs of the virtual internship environment into the transition plan creator system, the techniques described herein can provide a closed-loop workflow in which work-based learning performance directly informs formal transition planning documentation without requiring manual transcription or interpretation by educators.

The analytics server 110 can include a safe networking module 126. The safe networking module 126 can be a software component that facilitates encrypted communications between users and stakeholders participating in the internship program, including facilitators, mentors, and professionals external to the educational institution. For example, the safe networking module 126 can facilitate registration, onboarding, and task-related communications via secure channels that employ transport layer security protocols to protect message content during transmission between the user computing device 130, the parent, teacher, or counselor computing device 140, and any external computing devices operated by professionals or mentors.

In some implementations, the safe networking module 126 can perform identity verification operations by interfacing with third-party background check services via application programming interfaces, whereby the safe networking module 126 transmits identifying information about a prospective mentor or professional to the third-party service and receives a verification result indicating whether the individual satisfies safety criteria defined by the internship program. For example, the safe networking module 126 may transmit a name, date of birth, and social security number of a prospective mentor to a background check service, receive a verification result indicating no disqualifying criminal history, and store an association between the mentor's identifier and a verified status flag in a database accessible by the analytics server 110. The safe networking module 126 may employ natural language processing algorithms to analyze conversational messages exchanged between users and stakeholders, identify content that violates professional communication standards or contains inappropriate language, and generate warning messages presented to the user or stakeholder when such content is detected. For example, the safe networking module 126 may apply sentiment analysis models to detect hostile tone in a message drafted by a user to a mentor, flag the message as potentially inappropriate, and present a prompt to the user suggesting alternative phrasing that adheres to professional etiquette standards.

The safe networking module 126 may also generate connection recommendations by analyzing the user's career interests and progress data stored in the skills lens data structure, querying a database of vetted professionals and mentors to identify individuals whose expertise aligns with the user's career interests, and transmitting a recommendation message to the user computing device 130 suggesting that the user initiate communication with one or more of the identified professionals. For example, when the skills lens indicates that a user has completed tasks related to digital marketing and has expressed interest in marketing careers during onboarding, the safe networking module 126 may query a database of vetted professionals to identify marketing specialists who have previously mentored students in the internship program, select one or more professionals whose expertise matches the user's interests, and transmit a recommendation message to the user computing device 130 suggesting that the user send an introductory message to the selected professionals via the safe networking module 126.

The analytics server 110 can communicate with one or more devices via a network 128. The network 128 can be any type of wired or wireless communication network including local area networks, wide area networks, cellular networks, or the internet. For example, the network 128 can include combinations of Ethernet connections, Wi-Fi networks, 4G or 5G cellular data networks, or virtual private networks that enable secure communication between the analytics server 110 and client devices. The network 128 can transmit data packets between the analytics server 110 and the user computing device 130, the internship manager computing device 138, and the parent, teacher, or counselor computing device 140. In some implementations, the network 128 can carry task assignments generated by the AI assignment module 120, performance reports produced by the smart report generator 124, and conversational messages exchanged via the chatbot 116 and the safe networking module 126. The network 128 may employ transport layer security protocols to encrypt data in transit, preventing unauthorized access to user background information, task submissions, or assessment results. The network 128 may also facilitate integration with external systems such as learning management systems, communication platforms, or school rostering services via application programming interfaces.

The system can include one or more user computing devices 130. The user computing device 130 can be any type of computing device operated by a student or prospective employee participating in the virtual internship program, including smartphones, tablets, laptops, or desktop computers. For example, the user computing device 130 can include an iPhone, an Android smartphone, an iPad, a Chromebook, a Windows laptop, or a MacBook, each equipped with a display 132, input devices such as a keyboard or touchscreen, and network connectivity. The user computing device 130 can receive task assignments from the analytics server 110 via the network 128 and present the tasks within the virtual workspace 136 for the user to complete. In some implementations, the user computing device 130 can transmit user inputs, such as typed messages to the chatbot 116, completed task submissions, or requests for assistance, to the analytics server 110 for processing by the transformer model 114, the AI mentor model 118, the AI assignment module 120, or the AI skills assessment module 122.

The user computing device 130 may execute a web browser or mobile application that renders the virtual workspace 136 on the display 132, enabling the user to view task descriptions, access instructional materials, interact with the chatbot 116, and submit completed work. The user computing device 130 may also store local copies of accessibility settings, such as font size preferences, high-contrast modes, or text-to-speech configurations, which are synchronized with the analytics server 110 to adapt the virtual workspace 136 to the user's disability or learning style. The user computing device 130 can include a display 132.

The display 132 can be any type of electronic visual display, such as a liquid crystal display, an organic light-emitting diode display, or an electronic paper display, capable of presenting graphical user interfaces to the user. For example, the display 132 can be a touchscreen display that allows the user to interact directly with graphical elements such as buttons, text fields, and interactive widgets within the virtual workspace 136 and/or the dashboard 134. The display 132 can render the virtual workspace 136, presenting task assignments, instructional materials, and conversational interfaces for the chatbot 116 to facilitate user engagement with the virtual internship program. In some implementations, the display 132 can dynamically adjust visual properties such as font size, color contrast, or layout structure based on accessibility settings selected by the user and/or automatically applied by the analytics server 110 based on the user's disability. For example, the display 132 may present graphical elements with high-contrast color schemes for users with low vision, larger font sizes for users with dyslexia, or simplified layouts with structured task breakdowns for users on the autism spectrum. The display 132 may also present the dashboard 134, which provides progress insights, performance analytics, and recommendations based on the user's engagement with tasks and interactions with the virtual workspace 136.

The user computing device 130 can include a dashboard 134. The dashboard 134 can be a graphical user interface component that presents an overview of the user's progress within the virtual internship program, including tasks completed, tasks missing, tasks to be done, and summaries of strengths and development areas. For example, the dashboard 134 can include visual elements such as progress bars, pie charts, lists of tasks with completion status indicators, or textual summaries highlighting employability skills where the user excels and/or requires improvement. The dashboard 134 can display progress monitoring data to the user and to other stakeholders as per internship setup, enabling educators, parents, and/or mentors to track the user's engagement and performance over time.

In some implementations, the dashboard 134 can dynamically configure its layout and visual properties based on the user's disability and learning style. For example, the dashboard 134 may present larger text for users with visual impairments, enable text-to-speech functionality for users with dyslexia, apply high-contrast color schemes for users with low vision, or provide structured task breakdowns for users on the autism spectrum. The dashboard 134 may retrieve data from the analytics server 110 via the network 128, including employability skill indicators derived from the skills lens, accommodations and/or strategies applied during task completion, and predictive analytics generated by the AI mentor model 118 indicating the user's likelihood of success in future tasks. The dashboard 134 may also present personalized suggestions for improvement. For example, the dashboard 134 may recommend additional practice exercises, suggest alternative methods for task completion, or escalate issues to a human educator when the user's performance falls below a proficiency threshold.

In some implementations, the analytics server 110 can monitor user engagement within the virtual workspace 136 to detect early signs of disengagement and trigger adaptive interventions. The analytics server 110 may track metrics such as time elapsed since last login, number of tasks initiated but not completed, duration of inactivity within an open task, and frequency of help requests submitted via the chatbot 116. When one or more of these metrics satisfies a disengagement condition, such as inactivity exceeding a predefined threshold or repeated partial attempts without submission, the analytics server 110 can automatically generate engagement prompts directed to the user, for example by invoking the AI mentor model 118 to initiate a “daily stand-up” conversation or by presenting a reminder to “clock in” to the next mission. In some implementations, if the disengagement condition persists beyond a second threshold, the analytics server 110 may escalate by transmitting a notification to the internship manager computing device 138 or the parent, teacher, or counselor computing device 140, including a summary of the user's recent engagement patterns and outstanding tasks. This early detection and escalation mechanism enables stakeholders to intervene proactively to re-engage the user before extended disengagement negatively impacts skill development or completion of work-based learning requirements.

In some implementations, the virtual workspace 136 can be presented to the user as a company portal that simulates a professional workplace rather than an academic learning management system. For example, the virtual workspace 136 may display branding, navigation elements, and terminology associated with a fictitious employer, such as a movie production company, marketing agency, or technology startup, and may refer to the user as an “intern” rather than a student. Tasks generated by the AI assignment module 120 may be presented as “missions” or “projects,” each associated with one or more deliverables and deadlines analogous to workplace assignments. The analytics server 110 can periodically generate performance review artifacts that summarize the user's progression across employability skill dimensions based on the skills lens, and may award digital badges or a completion certificate when the user satisfies defined success criteria for one or more dimensions. For instance, when the skills lens indicates that the user has met or exceeded proficiency thresholds in communication, problem-solving, and technology use, the analytics server 110 may generate a performance review indicating mastery of entry-level professional competencies and issue a virtual certificate of internship completion. These artifacts can be included in reports generated by the smart report generator 124 and tagged with relevant transition domains, thereby serving as both motivational workplace-style feedback and formal documentation suitable for inclusion in an individualized education program.

The user computing device 130 can include a virtual workspace 136. The virtual workspace 136 can be a cloud-based platform that simulates a real-world work environment by presenting tasks, industry-specific software tools, and AI-driven support components to the user. For example, the virtual workspace 136 can simulate a professional environment such as a movie production company, a marketing agency, or a technology startup, where the user completes assignments related to scriptwriting, promotional material creation, or product development. The virtual workspace 136 can present at least one task for completion and can contain buttons configured to receive an input from the user. In some implementations, the virtual workspace 136 can include interactive elements such as text fields for submitting written work, file upload controls for attaching documents or multimedia files, buttons to request help from the chatbot 116, and navigation controls to move between tasks or access instructional resources. For example, the virtual workspace 136 may render a task card displaying a professional email drafting assignment, where the task card includes a text field accepting up to 500 characters of user-composed content, a file upload control allowing the user to attach reference documents in PDF or DOCX format, a button labeled “Ask Mentor” that transmits a user query to the chatbot 116 via the network 128, and a navigation menu listing all available tasks sorted by due date.

The virtual workspace 136 may adapt its presentation based on the user's disability or learning style by modifying text complexity, enabling text-to-speech or speech-to-text functionality, providing audio descriptions of visual content, or breaking tasks into smaller subtasks with clear step-by-step instructions. For example, when the analytics server 110 retrieves background information indicating that the user has dyslexia, the virtual workspace 136 may rewrite task descriptions to use sentences no longer than 15 words, increase font size to 16 points, apply a sans-serif typeface, enable a text-to-speech feature that reads task instructions aloud when the user clicks an audio icon, and subdivide a multi-part assignment into three discrete sub-tasks, each requiring no more than two actions. The virtual workspace 136 may also integrate with external systems such as learning management systems or communication platforms via application programming interfaces, enabling seamless access to the virtual internship alongside other educational content. For example, the virtual workspace 136 may implement an LTI 1.3-compliant interface that authenticates the user via single sign-on credentials maintained by a Canvas learning management system, retrieves course enrollment data from the Canvas API to confirm that the user is registered for an internship course, and transmits task completion status updates to the Canvas gradebook when the user submits a task within the virtual workspace 136.

The system can include one or more internship manager computing device 138. The internship manager computing device 138 can be any type of computing device operated by an administrator who defines the structure of the internship program, assigns tasks, monitors progress, and reviews reports generated by the smart report generator 124. For example, the internship manager computing device 138 can include a desktop computer, laptop, or tablet equipped with a web browser or dedicated application that accesses an administrative interface provided by the analytics server 110. The internship manager computing device 138 can transmit configuration data to the analytics server 110, including session schedules, participant roles, contact details, topics or tasks to be covered, and rules for automated reminders or escalation protocols.

In some implementations, the internship manager computing device 138 can receive reports from the smart report generator 124 that summarize student progress, participation rates, task completion statistics, and enrollment data, enabling the administrator to evaluate the effectiveness of the internship program. For example, the smart report generator 124 may generate a report indicating that 87% of enrolled users in a cohort have completed at least one task within the first week, that the average time to complete a professional email drafting task is 42 minutes, and that users with dyslexia have an average communication skills score of 6.1 out of 10 after completing three tasks, such that the administrator can compare these metrics to predefined targets or historical data from previous cohorts to determine whether adjustments to task difficulty or support resources are warranted.

The internship manager computing device 138 may access a dashboard that presents visualizations of cohort performance, including comparative metrics showing how individual users perform relative to aggregate benchmarks for similar internship programs. For example, the dashboard may display a bar chart showing the distribution of employability skill scores across all users in a cohort, a line graph depicting the average task completion rate over time, and a table listing users whose performance falls below proficiency thresholds in one or more skill dimensions, such that the administrator can identify trends indicating whether specific accommodations or coaching strategies are effective for particular disability groups or whether certain tasks require redesign to better align with user capabilities. The internship manager computing device 138 may also initiate manual interventions, such as assigning additional tasks, modifying task parameters, or escalating unresponsive users to parents, teachers, or counselors via the safe networking module 126. For example, when the dashboard indicates that a user has not submitted any tasks for a period exceeding seven days, the internship manager computing device 138 may transmit a message to the safe networking module 126 requesting that an automated notification be sent to the user's registered email address and that a secondary notification be delivered to a parent or counselor listed in the user's background information, such that the administrator can intervene proactively to re-engage the user before disengagement becomes irreversible.

The system can include one or more parent, teacher, or counselor computing device 140. The parent, teacher, or counselor computing device 140 can be any type of computing device operated by a stakeholder who monitors the user's progress, reviews reports generated by the smart report generator 124, and provides additional support or guidance. For example, the parent, teacher, or counselor computing device 140 can include a smartphone, tablet, laptop, or desktop computer equipped with a web browser or mobile application that accesses reports and dashboards provided by the analytics server 110. The parent, teacher, or counselor computing device 140 can receive reports from the smart report generator 124 that include employability skill indicators derived from the skills lens, accommodations or strategies derived from the success matrix, and performance comparisons to other users with similar disabilities or backgrounds.

In some implementations, the parent, teacher, or counselor computing device 140 can receive automated notifications or alerts when the user misses a deadline, demonstrates low engagement, or requires additional support, enabling timely intervention to prevent disengagement. For example, when the analytics server 110 detects that the user has not submitted any tasks for a period exceeding five days, the analytics server 110 may transmit a notification message to the parent, teacher, or counselor computing device 140 via the network 128, where the notification message includes a summary of the user's recent engagement patterns, a list of outstanding tasks with their respective due dates, and a recommendation to contact the user directly to discuss potential barriers to participation. The parent, teacher, or counselor computing device 140 may communicate with the analytics server 110 via the network 128 to access the user's dashboard 134, review task submissions, provide feedback on completed work, or send messages to the user via the safe networking module 126. The parent, teacher, or counselor computing device 140 may also access legally compliant transition-planning documentation produced by the smart report generator 124, which tags employability skill indicators with IDEA transition domains and Perkins employability skills framework categories, facilitating inclusion of the internship results in the user's Individualized Education Program.

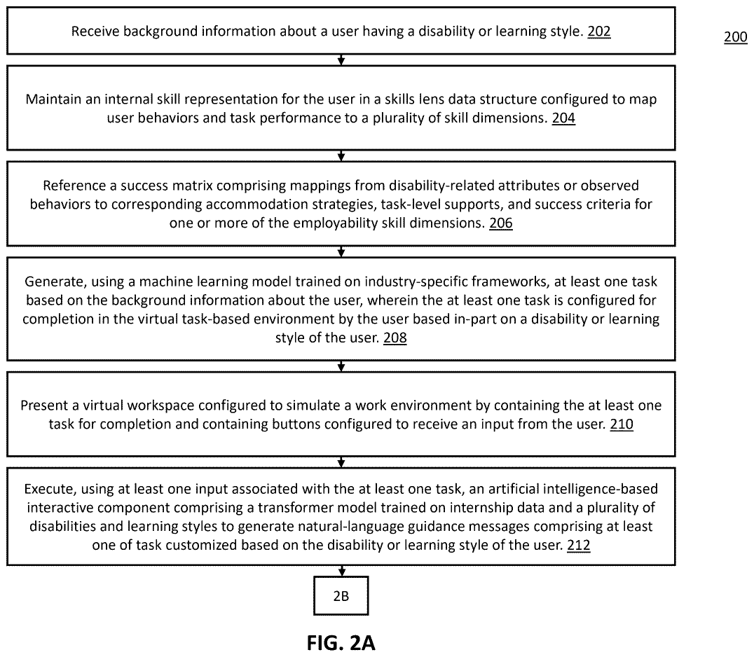

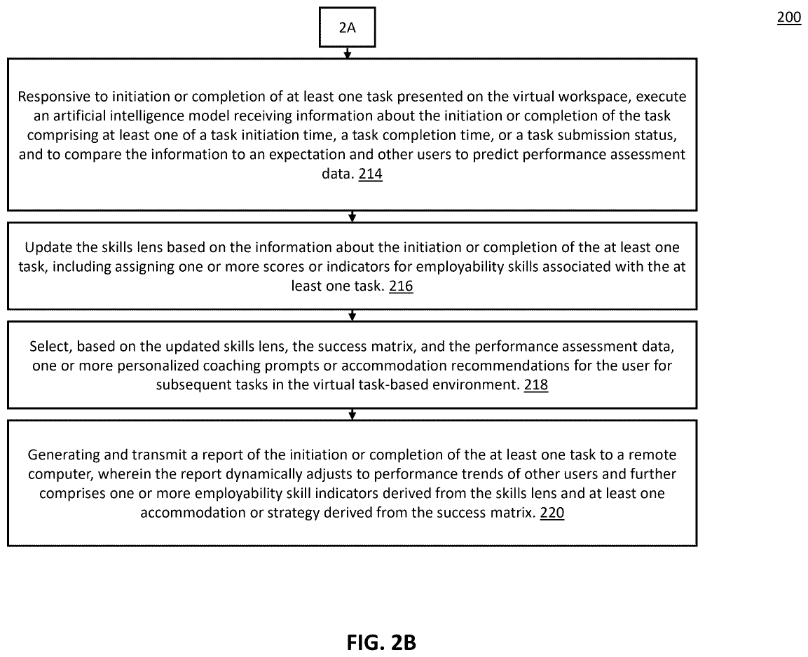

Referring now to FIGS. 2A-2B, illustrated is a flowchart of a method 200 for generating and presenting a virtual task-based workspace and executing an AI-based interactive component based on user background information. The method 200 can be executed, performed, or otherwise carried out by any of the computing systems or devices described herein, such as the analytics server. In some embodiments, the method 200 may include fewer or more steps.

The method 200 can include receiving background information about a user having a disability or learning style (the step 202). The analytics server can receive information describing the user's demographic background, financial background, family structure, interests, experiences, capabilities, learning styles, and any disabilities via a web form presented on the user computing device. For example, the background information may include data indicating favorite courses, hobbies, extracurricular activities, notable achievements, previous internships, specific disability labels such as dyslexia or autism spectrum disorder, or behavioral patterns indicating visual impairments or attention difficulties. The analytics server can receive the background information during an onboarding workflow executed after the user registers for the virtual internship program by transmitting authentication credentials to an application programming interface of the analytics server.

The onboarding workflow may prompt the user or a stakeholder to complete web forms that collect personal data, which is transmitted to the analytics server via encrypted communication channels to satisfy privacy regulations such as the Family Educational Rights and Privacy Act (FERPA) and the General Data Protection Regulation (GDPR). The analytics server may parse the received background information to extract structured data fields corresponding to disability types, learning preferences, career interests, and employability skill baselines by applying one or more natural language processing algorithms to free-text entries and mapping responses to predefined categories stored in a reference database. The structured data can be stored in a database managed by the analytics server and subsequently accessed by machine learning models to tailor task generation, coaching interactions, and performance assessments to the user's specific needs.

The method 200 can include maintaining an internal skill representation for the user in a skills lens data structure configured to map user behaviors and task performance to a plurality of employability skill dimensions (the step 204). The analytics server can maintain a skills lens data structure that functions as a multi-dimensional vector representation of the user's employability skills across dimensions such as applied academic skills, critical thinking skills, interpersonal skills, personal qualities, resource management, information use, communication skills, systems thinking, and technology use. For instance, the skills lens may assign numerical scores or qualitative indicators to each dimension based on initial assessments during onboarding or default values derived from cohort data for users with similar disabilities. The analytics server can update the skills lens continuously as the user interacts with the virtual workspace, submits tasks, and communicates with the chatbot. Each interaction, including chatbot queries requesting clarification on task requirements, submissions of completed assignments, and use of accessibility features such as text-to-speech, can be mapped to one or more employability skill dimensions using a predefined ruleset or machine-learned model. The analytics server may store the skills lens data structure in a database or in-memory cache to enable real-time retrieval and updating during task performance. The skills lens can provide a unified internal representation that allows the AI mentor model to identify skill dimensions below proficiency thresholds and select personalized coaching prompts accordingly.

In some implementations, the skills lens data structure can include an employability skill dimension corresponding to AI literacy. The AI literacy dimension can reflect the user's ability to interact effectively and responsibly with AI tools within the virtual internship environment, including the chatbot, the AI mentor model, and any embedded AI assistants used for content creation or task support. The analytics server may update the AI literacy dimension based on interaction patterns such as the quality and specificity of prompts submitted to AI components, adherence to ethical use guidelines presented within the virtual workspace, and the extent to which the user verifies or refines AI-generated outputs rather than copying them verbatim. For example, when a user requests examples of professional email wording from the chatbot, incorporates the suggestions into a draft while maintaining original content, and follows system guidance regarding disclosure and originality, the analytics server may increment the AI literacy dimension in the skills lens. The AI mentor model may also reference the AI literacy dimension when selecting coaching prompts, such as recommending additional micro-lessons on responsible AI use when the dimension falls below a proficiency threshold.

The method 200 can include referencing a success matrix comprising mappings from disability-related attributes or observed behaviors to corresponding accommodation strategies, task-level supports, and success criteria for one or more of the employability skill dimensions (the step 206). The analytics server can access a success matrix data structure stored in memory or a database, wherein the data structure contains a plurality of entries that associate disability labels or patterns of observed behaviors with task-level accommodations, workflow modifications, coaching strategies, and success criteria for one or more employability skill dimensions. For example, an entry in the success matrix may map the disability label “dyslexia” to accommodations such as simplified text rewritten to an eighth-grade reading level, font sizes increased to 16 points or larger, and text-to-speech functionality enabled by default, along with coaching strategies emphasizing visual learning aids such as color-coded diagrams or flowcharts and success criteria adjusted for reading comprehension tasks to account for processing speed differences.

In some implementations, the success matrix can be implemented as a structured data table or rules engine in which each entry associates (i) a disability label and/or behavioral pattern with (ii) one or more accommodations, coaching strategies, and success criteria linked to employability skill dimensions. For example, a success matrix entry for a user with low vision may specify accommodations such as presenting instructions in a minimum 18-point sans-serif font, enabling high-contrast color schemes by default, providing printable transit maps at 36- to 72-point font size, and highlighting the location of braille signage within simulated transit scenarios. The same entry may specify coaching strategies emphasizing spatial orientation and route planning, and success criteria adjusted for tasks involving visual scanning. As another example, a success matrix entry for a user exhibiting behaviors consistent with attention deficit hyperactivity disorder (ADHD) may specify accommodations such as breaking complex assignments into smaller sub-tasks with explicit time estimates, increasing the frequency of interim checkpoints, and enabling timed reminders within the virtual workspace 136. The entry may further specify coaching strategies that encourage use of visual checklists and structured routines, and success criteria that account for sustained engagement across multiple shorter work sessions. The analytics server can reference these entries when generating tasks via the AI assignment module and when selecting coaching prompts via the AI mentor model, such that the same underlying task template is presented and supported differently for users with distinct disability profiles.

In some implementations, disability-related attributes used to query the success matrix need not be limited to explicit disability labels provided during onboarding. The analytics server 110 can infer provisional disability indicators based on observed behavioral patterns captured within the skills lens data structure and interaction logs. For example, repeated requests to increase font size, extended dwell time on text-heavy instructions, and frequent activation of text-to-speech functionality may be interpreted as indicative of a visual processing difficulty, whereas frequent task switching, long periods of inactivity followed by bursts of activity, and repeated missed intermediate deadlines may be interpreted as indicative of an attention-related condition. When such behavioral patterns meet predefined criteria, the analytics server may generate an inferred disability indicator and use that indicator to query the success matrix, thereby selecting accommodations and coaching strategies that address the observed needs even when no formal disability diagnosis has been entered. In some implementations, the analytics server may tag inferred indicators as provisional and adjust them over time as additional behavioral data are collected, reducing the risk of misclassification while still providing responsive support.

The analytics server can reference the success matrix after receiving background information about the user's disability during onboarding in the step 202 or after detecting behavioral patterns indicative of a disability through analysis of user interactions captured in the skills lens data structure maintained in the step 204. The referencing operation may occur during task generation in the step 208 to incorporate accommodations into task parameters before the task is presented to the user or during coaching interactions executed by the AI mentor model to select prompts that address the user's specific challenges identified through performance analysis. The analytics server may query the success matrix using the user's disability-related attributes retrieved from the background information received in the step 202 or derived from observed behaviors captured in the skills lens data structure, wherein the query identifies entries matching the user's disability label or behavioral pattern. The query can return one or more accommodation strategies, such as extended time allocations for task completion or altered presentation modalities replacing text-heavy instructions with audio narration, which are subsequently applied by the AI assignment module when generating tasks in the step 208 or by the AI mentor model when selecting coaching prompts in subsequent operations.

The method 200 can include generating, using a machine learning model trained on industry-specific frameworks, at least one task based on the background information about the user, wherein the at least one task may be configured for completion in the virtual task-based environment by the user based in part on a disability or learning style of the user (the step 208). The task can be generated by the AI assignment module of the analytics server. The AI assignment module can execute a machine learning model trained on datasets incorporating industry-specific frameworks such as the Perkins Employability Skills Framework and workplace competency models to produce task assignments that simulate real-world work experiences. For instance, the machine learning model may generate tasks such as drafting a professional email to a fictional supervisor, creating a promotional flyer for a fictional product launch, conducting a simulated customer discovery interview via a chatbot-mediated scenario, or producing a video presentation summarizing a project deliverable, each tailored to the user's career interests, current employability skill scores retrieved from the skills lens data structure, and disability-related accommodations retrieved from the success matrix.

The AI assignment module can generate the task after the analytics server has received background information in the step 202 and referenced the success matrix in the step 206 to identify applicable accommodations, such that the task parameters incorporate accessibility features before the task is presented to the user. The task generation process may be triggered by the user's progression through an onboarding workflow, completion of a previous task, or a schedule defined by an internship manager via the internship manager computing device, such that tasks are assigned at predetermined intervals or in response to user actions indicating readiness for additional work. The AI assignment module may modify task parameters by incorporating accommodations retrieved from the success matrix, such as providing extended time allocations for task completion when the user's disability is associated with processing speed limitations, altering the presentation modality from text-heavy instructions to video demonstrations narrated by a text-to-speech engine when the user has dyslexia, simplifying language complexity by rewriting task descriptions to use sentences no longer than twelve words and vocabulary at an eighth-grade reading level, or prompting the user to activate assistive technology features such as screen readers or high-contrast display modes before beginning the task.

The generated task can be transmitted to the user computing device via the network for presentation within the virtual workspace, where the user can view task descriptions rendered in a format adapted to the user's disability, access relevant materials such as reference documents or instructional videos, and submit completed work via interactive controls such as file upload buttons or text submission fields.

The method 200 can include presenting a virtual workspace configured to simulate a work environment by containing the at least one task for completion and containing buttons configured to receive an input from the user (the step 210). The virtual workspace can be presented by the analytics server to the user computing device. The analytics server can transmit data to the user computing device that renders a cloud-based platform simulating a professional environment, such as a movie production company, marketing agency, or technology startup, within which the user completes assignments related to scriptwriting, promotional material creation, or product development. For example, the virtual workspace 136 may display a project dashboard with task cards, where each card contains a task title, description, due date, and a button labeled “Start Task” or “Submit Work,” alongside a sidebar providing access to instructional resources and a help button to invoke the chatbot.

The analytics server can present the virtual workspace after generating at least one task in the step 208 and determining that the user has completed onboarding or is ready to begin work on the assigned tasks. The presentation may occur upon the user logging into the virtual internship platform via a web browser or mobile application on the user computing device. The analytics server may render the virtual workspace with interactive elements such as text fields for submitting written work, file upload controls for attaching documents or multimedia files, buttons to request assistance from the chatbot, and navigation controls to move between tasks or access supplementary materials. The virtual workspace may also adapt its visual presentation based on accessibility settings stored for the user, such as applying high-contrast color schemes for users with low vision or enabling text-to-speech narration for users with dyslexia.

The method 200 can include executing an artificial intelligence-based interactive component comprising a transformer model trained on internship data and a plurality of disabilities and learning styles (the step 212). The artificial intelligence-based interactive component can be executed by the analytics server. The analytics server can execute a transformer model implemented as a large language model, which has been trained on text corpora including internship data, workplace communication models, mentorship scripts, and disability accommodation strategies, to generate contextually appropriate responses that account for the user's disability or learning style. For example, the transformer model may generate a response to a user query about how to structure a professional email by retrieving a success matrix entry associating dyslexia with simplified language accommodations, such that the response includes step-by-step instructions written in sentences no longer than twelve words, avoids complex vocabulary, and offers an audio playback option that narrates the instructions using a text-to-speech engine.

The analytics server can execute the artificial intelligence-based interactive component in response to the user clicking a help button within the virtual workspace, submitting a question via a chat interface provided by the chatbot, or upon detection of triggers such as repeated mistakes in task completion or prolonged inactivity exceeding a threshold duration. For example, when the AI skills assessment module detects that a user has submitted a task with formatting errors in three consecutive attempts, the analytics server may automatically invoke the transformer model to generate a troubleshooting message that identifies the specific formatting issue, explains how to correct the issue using a numbered list of actions, and includes a link to a just-in-time lesson on professional document formatting. The execution may occur continuously during the user's session in the virtual workspace, enabling real-time conversational interactions between the user and the chatbot powered by the transformer model.

The analytics server may receive user inputs from the chatbot, tokenize the input sequence by converting each word or sub-word into a numerical representation, apply multi-head attention layers to compute relationships among tokens across the sequence by calculating attention scores that quantify the relevance of each token to every other token, and produce output sequences that form natural language guidance, step-by-step instructions, troubleshooting suggestions, or encouragement messages. For example, when the transformer model receives an input sequence indicating that a user is struggling with a customer discovery interview task, the transformer model may tokenize the input into discrete units representing words such as “customer,” “discovery,” “interview,” and “struggle,” apply multi-head attention layers to identify that the user's difficulty relates to formulating open-ended questions, and generate an output sequence that provides a structured template for crafting open-ended questions such as “What challenges do you face when using [product]?” along with an explanation of why open-ended questions elicit more informative responses than closed-ended questions. The generated responses can be transmitted to the user computing device via the network and presented to the user via the chatbot interface within the virtual workspace, providing personalized coaching that adapts dynamically based on the user's progress, engagement patterns, and disability-related needs as reflected in the skills lens data structure and the success matrix.

In some embodiments, the analytics server can use at least one input associated with the at least one task, such as a user query about the task, a partial task submission, or a request for clarification, to condition generation of the natural-language guidance message. In some implementations, the analytics server can provide the transformer model with both the task-specific input and user-specific context including the user's disability or learning style, one or more relevant entries from the success matrix, and current values from the internal attribute representation, so that the transformer model generates a guidance message that is customized based on the disability or learning style of the user. The customized guidance message can then be displayed within the virtual workspace in association with the at least one task, for example as an overlay, tooltip, or chat response that assists the user in initiating or completing the at least one task.

In one non-limiting example, a user who has been identified as having dyslexia opens a professional email drafting task in the virtual workspace and clicks a “Help me start this email” button. This button press is treated as an input associated with the task, and the analytics server provides the transformer model with the text of the task instructions, the user's partial draft (if any), and context indicating that the user's disability label is dyslexia. The transformer model retrieves a success matrix entry specifying simplified language accommodations for dyslexia and generates a natural-language guidance message that begins with a suggested subject line and first sentence, written in short, high-frequency words and broken into brief clauses. The system displays this customized guidance message adjacent to the email editor within the virtual workspace so that the user can read or listen to the suggested text and use it to initiate or complete the email task.

The method 200 can include executing an artificial intelligence model and comparing performance to an expectation and other users responsive to initiation or completion of at least one task presented on the virtual workspace (the step 214). The analytics server can execute the AI skills assessment module to receive information about the initiation or completion of the task and compare the user's performance to predefined expectations and the performance of other users. For example, the analytics server may analyze task submissions to identify patterns of errors, measure success rates, track time taken for task completion, and determine relative proficiency in multiple employability skill dimensions such as communication, problem-solving, or technology use. The analytics server can execute the artificial intelligence model in response to the user submitting a completed task via the virtual workspace or in response to detecting that the user has initiated a task without making progress for a threshold duration. For instance, the execution may occur immediately upon the user clicking a submit button within the virtual workspace or upon detecting that the user has opened a task assignment but has not submitted any work within a predefined time period, such as 24 hours.

The analytics server may retrieve the skills lens data structure for the user from a database, access a repository of aggregate performance data for other users with similar disabilities or backgrounds, and compute percentile rankings or deviation scores that indicate the user's standing relative to peers. The analytics server may also compare the user's task completion time, error rates, or quality metrics to predefined benchmarks derived from industry-specific frameworks or organizational performance standards, thereby generating a comprehensive assessment of the user's employability skill development.

The analytics server can execute the artificial intelligence model by supplying task performance information about the initiation or completion of the at least one task. In some implementations, the task performance information can include a timestamp indicating when the user first opened or initiated the task, a timestamp indicating when the user submitted or completed the task, and a task submission status indicating whether the task was completed successfully, completed with errors, or left incomplete. The artificial intelligence model can compare this task performance information to predefined expectations, such as target completion times or expected completion rates for the task, and to aggregate performance information for other users who have performed similar tasks, including users with similar disabilities or learning styles. Based on these comparisons, the artificial intelligence model can generate performance assessment data, such as an employability skill score for one or more skill dimensions associated with the task, a deviation from the predefined expectations, or a relative proficiency measure indicating the user's standing with respect to the other users.

In one non-limiting example, a user is assigned a professional email drafting task with an expected completion time of 45 minutes. When the user opens the task in the virtual workspace, the analytics server records a task initiation time, and when the user clicks “Submit,” the server records a task completion time of 38 minutes and a submission status of “completed.” The artificial intelligence model receives this task performance information and compares the 38-minute completion time to a predefined expectation of 45 minutes, as well as to aggregate completion times for a cohort of similar users, which have an average of 52 minutes. Based on these comparisons, the model generates performance assessment data indicating that the user exceeded the expected timing benchmark and is in the 75th percentile for completion speed relative to the cohort for the time-management skill dimension.

The method 200 can include updating the skills lens based on the information about the initiation or completion of the at least one task, including assigning one or more scores or indicators for employability skills associated with the at least one task (the step 216). The analytics server can update the skills lens data structure by mapping individual user interactions within the virtual workspace, including chatbot queries, task submissions, and use of accessibility features, to one or more employability skill dimensions using a predefined ruleset or machine-learned model. For instance, the analytics server may assign a higher score to the communication skills dimension based on the user submitting a well-structured written report or may increment the technology use dimension based on the user successfully employing assistive technology features such as text-to-speech during task completion.

The analytics server can update the skills lens after the AI skills assessment module has completed its analysis of the task initiation or completion data generated in the step 214. For example, the update may occur within seconds of the user submitting a task, enabling the system to immediately reflect the user's most recent performance in the internal skill representation. The analytics server may retrieve the current skills lens data structure from memory or a database, apply one or more scoring algorithms that map task performance metrics to employability skill dimensions, and store the updated skills lens back to the database for subsequent retrieval during coaching interactions or report generation. In some implementations, the analytics server may incrementally adjust a time-series record of the user's skill indicators to enable detection of skill growth trends across multiple tasks in the virtual task-based environment, thereby providing a longitudinal view of the user's development over the course of the internship program.

The method 200 can include selecting, based on the updated skills lens and the success matrix, one or more personalized coaching prompts or accommodation recommendations for the user for subsequent tasks in the virtual task-based environment (the step 218). The personalized coaching prompts or accommodation recommendations can be selected by the analytics server. The analytics server can select one or more personalized coaching prompts or accommodation recommendations by identifying at least one employability skill dimension below a proficiency threshold and applying a corresponding success matrix entry to generate targeted coaching instructions specific to the user's disability or learning style. For example, when the updated skills lens indicates that the user's communication skills dimension has a score below a predefined proficiency threshold, the analytics server may query the success matrix to retrieve coaching strategies such as recommending a just-in-time lesson on professional email writing or prompting the user to review examples of effective workplace communication. The analytics server can select the personalized coaching prompts or accommodation recommendations after the skills lens has been updated in the step 216, such that the selection process operates on the most current representation of the user's employability skill development. For example, the selection may occur immediately after the skills lens update completes, enabling the analytics server to present coaching prompts to the user during their next session in the virtual workspace or to proactively send a notification recommending a specific resource or accommodation.

The analytics server may retrieve the success matrix from a database, query the success matrix using the user's disability-related attributes or observed behavior patterns extracted from the skills lens, and obtain one or more task-level accommodations, workflow modifications, or coaching strategies that correspond to the identified skill deficiencies. The selected coaching prompts or accommodation recommendations may then be transmitted to the user computing device via the network for presentation within the virtual workspace or via the chatbot, enabling the user to receive real-time adaptive support without requiring manual intervention by educators.

The analytics server can further use the performance assessment data when selecting the personalized coaching prompts or accommodation recommendations. In some implementations, the analytics server can combine the updated data structure, which reflects current scores or indicators for the skill dimensions, with the performance assessment data indicating deviations from predefined expectations and relative proficiency among other users to determine which skills require the most urgent support. For example, when the performance assessment data indicates that the user's time-management performance falls below a target completion benchmark and is in a lower percentile relative to peers, while the updated data structure shows a corresponding low score in a time-management skill dimension, the analytics server may query the success matrix to retrieve accommodations and coaching strategies specific to time management for the user's disability or learning style. The analytics server can then select a coaching prompt that recommends breaking upcoming tasks into smaller sub-tasks with explicit time estimates and an accommodation that enables automated reminders for interim deadlines and present these selections to the user for subsequent tasks in the virtual task-based environment.

The method 200 can include generating and transmitting a report of the initiation or completion of the at least one task to a remote computer, wherein the report dynamically adjusts to performance trends of other users and further comprises one or more employability skill indicators derived from the skills lens and at least one accommodation or strategy derived from the success matrix (the step 220). The report can be generated and transmitted by the smart report generator executing on the analytics server. The smart report generator can retrieve data from the skills lens data structure to obtain one or more employability skill scores for the user, such as numerical scores ranging from 0 to 10 for dimensions including communication skills, critical thinking skills, interpersonal skills, personal qualities, resource management, information use, systems thinking, and technology use, among others. The smart report generator can query the success matrix using the user's disability label or observed behavior patterns to identify one or more accommodations or strategies that were applied during task completion, such as extended time allocations, altered presentation modalities, simplified instructions rewritten to an eighth-grade reading level, or assistive technology prompts enabling text-to-speech functionality.

The smart report generator can access a database storing aggregate performance data for a cohort of users with similar disabilities or backgrounds who have completed the same tasks, such as average employability skill scores, median task completion times, or distributions of error rates across the cohort. The smart report generator can compute benchmarking statistics by comparing the user's employability skill scores to the aggregate skills lens values for the cohort, for example, by calculating a percentile ranking indicating that the user's communication skills score of 6.3 exceeds 68% of users in the cohort or by determining a deviation score representing the number of standard deviations by which the user's critical thinking skills score differs from the cohort mean. The smart report generator can generate the report after the personalized coaching prompts or accommodation recommendations have been selected in the step 218, such that the report reflects the most recent coaching interventions and skill assessments performed by the AI mentor model.

In some implementations, the smart report generator can generate the report immediately following the selection of coaching prompts in the step 218, or on a periodic basis such as weekly or monthly, or in response to a request transmitted from the internship manager computing device or the parent, teacher, or counselor computing device to review the user's progress. For example, when the internship manager computing device transmits a request to the analytics server specifying a report interval of seven days and a target date corresponding to the end of a reporting period, the smart report generator may retrieve the skills lens data structure for the user as of the target date, query the success matrix to identify accommodations applied during the reporting period, access aggregate performance data for the cohort from the database, compute percentile rankings for each employability skill dimension by comparing the user's scores to the cohort aggregate values, and compile a report document including a summary of tasks completed, tasks missing, and tasks to be done during the reporting period, along with employability skill indicators such as the user's communication skills score of 6.3 and corresponding percentile ranking of 68%, and at least one accommodation such as simplified instructions or extended time that was applied during task completion.

The smart report generator can produce legally compliant transition-planning evidence by tagging each employability skill indicator with at least one of an Individuals with Disabilities Education Act transition domain and a Perkins employability skills framework category, such that the communication skills indicator is tagged with an IDEA Employment transition domain and a Perkins Communication Skills category, the critical thinking skills indicator is tagged with an IDEA Postsecondary Education transition domain and a Perkins Critical Thinking category, and the interpersonal skills indicator is tagged with an IDEA Independent Living transition domain and a Perkins Interpersonal Skills category, among others, thereby facilitating inclusion of the internship results in the user's Individualized Education Program without imposing additional reporting burdens on special education staff. The smart report generator can transmit the generated report to the internship manager computing device and the parent, teacher, or counselor computing device via the network, such that stakeholders can access the report through a web browser or mobile application and monitor the user's progress, review employability skill development trends across multiple reporting periods, and identify areas where additional support or intervention may be warranted based on the performance comparisons to other users in the cohort.

### Non-limiting Example

In one non-limiting example, an educational organization deploys the virtual internship system as part of a career readiness program for high school students with disabilities. A student, Alex, is a seventeen-year-old with low vision and attention deficit hyperactivity disorder (ADHD) who enrolls in a virtual internship simulating employment at a fictitious movie production company. During onboarding, the system receives background information about Alex, including disability labels, preferred learning styles, and career interests. The system initializes a skills lens data structure with baseline scores for employability skill dimensions such as communication, critical thinking, interpersonal skills, technology use, and AI literacy, and references a success matrix that contains entries for low vision and ADHD. The success matrix entries specify accommodations such as increased font size, high-contrast color schemes, task chunking, explicit time estimates, and reminders, along with coaching strategies (for example, visual checklists and step-by-step instructions) and success criteria tailored to these disability profiles.

Using its task generation capabilities, the system produces Alex's first mission: drafting a professional email pitching a short film concept to a fictional producer. The system applies Alex's background information and relevant success matrix entries to adapt the task parameters. The email assignment is presented in a virtual workspace as a mission within a company-branded portal that refers to Alex as an “intern” and organizes work as project cards. The task description is rewritten into short sentences at an eighth grade reading level, rendered in a large sans-serif font with a high-contrast color scheme, and divided into sub-tasks with explicit time estimates. As Alex works, an AI-based interactive component, including a transformer model and conversational interface, provides guidance; when Alex asks how to start the email, the model generates a simplified explanation of email structure and a template, and offers the option to hear the guidance via text-to-speech. These interactions are recorded as evidence for communication and AI literacy dimensions and used to update the skills lens.

When Alex submits the email, an AI skills assessment module evaluates the content against a rubric derived from workplace communication standards, computes a communication skills score, and compares that score to aggregate data for a cohort of users with similar disabilities. The module updates Alex's skills lens to reflect an improved communication skills score and an incremental gain in AI literacy based on effective use of AI guidance. An AI mentor component retrieves the updated skills lens, identifies communication skills as still below a desired proficiency threshold, and queries the success matrix to select coaching strategies emphasizing brief, focused practice and additional visual supports. The AI mentor generates a personalized coaching prompt recommending a short micro-lesson on persuasive subject lines and suggesting use of text-to-speech to review drafts aloud; this prompt is delivered in the virtual workspace before Alex's next mission. Over time, the system generates additional missions, such as creating promotional materials and drafting social media posts, each adapted using the success matrix to incorporate accommodations and task-level supports appropriate to Alex's needs.

Throughout the program, the system monitors Alex's engagement, tracking metrics such as time since last login, tasks initiated but not completed, and inactivity within open tasks. When Alex does not log in for several days and an upcoming mission is approaching its due date, the system detects a disengagement condition and invokes the AI mentor to initiate a “daily stand-up” conversation in the virtual workspace. If Alex remains inactive beyond a second threshold, the system escalates by sending notifications to an internship manager and a teacher, summarizing recent engagement patterns and outstanding tasks. As missions are completed, a reporting component periodically compiles reports using data from the skills lens and success matrix, including current scores and trends for each employability skill dimension, records of accommodations applied, and benchmarking statistics relative to similar users. Each skill indicator is tagged with corresponding transition domains and employability skills categories, such as IDEA transition domains and Perkins employability skills, creating documentation that can be incorporated into transition-planning records.

At the conclusion of the internship, the system generates a performance review summarizing Alex's progression, such as an increase in communication skills and AI literacy scores, and issues a digital badge and completion certificate within the company-portal interface. A final report is transmitted to the teacher and to a transition plan creator system operated by the school district. The transition plan creator system receives employability skill indicators, accommodation histories, and framework tags from the internship system, and uses this information to propose updated transition goals, objectives, and recommended accommodations for Alex's individualized education program.

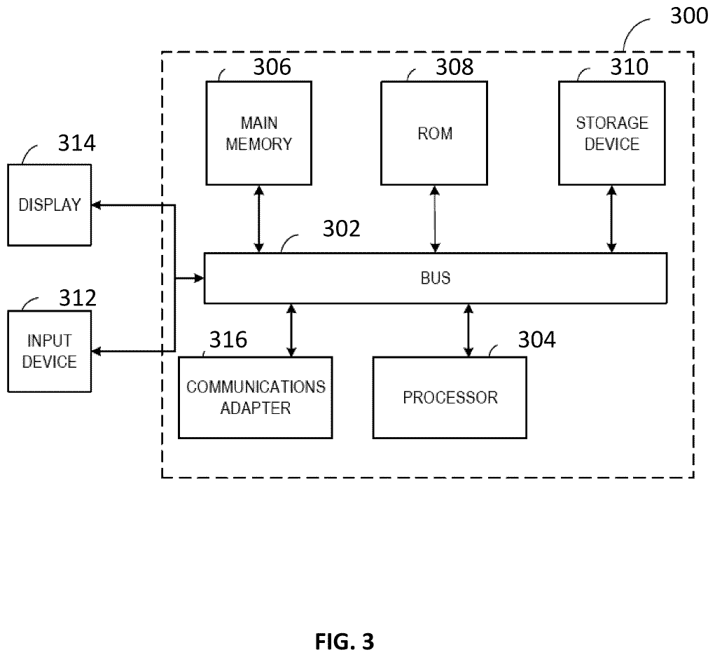

FIG. 3 is a component diagram of an example computing system suitable for use in the various implementations described herein, according to an example implementation. One or more steps of the methods and processes discussed herein can be performed by the computing system depicted in FIG. 3.

The computing system 300 includes a bus 302 or other communication component for communicating information and a processor 304 coupled to the bus 302 for processing information. The computing system 300 also includes main memory 306, such as a RAM or other dynamic storage device, coupled to the bus 302 for storing information, and instructions to be executed by the processor 304. Main memory 306 can also be used for storing position information, temporary variables, or other intermediate information during the execution of instructions by the processor 304. The computing system 300 may further include a ROM 308 or other static storage device coupled to the bus 302 for storing static information and instructions for the processor 304. A storage device 310, such as a solid-state device, magnetic disk, or optical disk, is coupled to the bus 302 for persistently storing information and instructions.

The computing system 300 may be coupled via the bus 302 to a display 314, such as a liquid crystal display, or active-matrix display, for displaying information to a user. An input device 312, such as a keyboard including alphanumeric and other keys, may be coupled to the bus 302 for communicating information, and command selections to the processor 304. In another implementation, the input device 312 has a touch screen display. The input device 312 can include any type of biometric sensor, or a cursor control, such as a mouse, a trackball, or cursor direction keys, for communicating direction information and command selections to the processor 304 and for controlling cursor movement on the display 314.

In some implementations, the computing system 300 may include a communications adapter 316, such as a networking adapter. Communications adapter 316 may be coupled to bus 302 and may be configured to enable communications with a computing or communications network or other computing systems. In various illustrative implementations, any type of networking configuration may be achieved using communications adapter 316, such as wired (e.g., via Ethernet), wireless (e.g., via Wi-Fi, Bluetooth), satellite (e.g., via GPS) pre-configured, ad-hoc, LAN, WAN, and the like.

According to various implementations, the processes of the illustrative implementations that are described herein can be achieved by the computing system 300 in response to the processor 304 executing an implementation of instructions contained in main memory 306. Such instructions can be read into main memory 306 from another computer-readable medium, such as the storage device 310. Execution of the implementation of instructions contained in main memory 306 causes the computing system 300 to perform the illustrative processes described herein. One or more processors in a multi-processing implementation may also be employed to execute the instructions contained in main memory 306. In alternative implementations, hard-wired circuitry may be used in place of or in combination with software instructions to implement illustrative implementations. Thus, implementations are not limited to any specific combination of hardware circuitry and software.

The implementations described herein have been described with reference to drawings. The drawings illustrate certain details of specific implementations that implement the systems, methods, and programs described herein. However, describing the implementations with drawings should not be construed as imposing on the disclosure any limitations that may be present in the drawings.

As used herein, the term “circuit” may include hardware structured to execute the functions described herein. In some implementations, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some implementations, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating the achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some implementations, the one or more processors may be embodied in various ways. The one or more processors may be constructed in a manner sufficient to perform at least the operations described herein. In some implementations, the one or more processors may be shared by multiple circuits (e.g., circuit A and circuit B may comprise or otherwise share the same processor, which, in some example implementations, may execute instructions stored or otherwise accessed via different areas of memory). Alternatively or additionally, the one or more processors may be structured to perform or otherwise execute certain operations independent of one or more co-processors.

In other example implementations, two or more processors may be coupled via a bus to enable independent, parallel, pipelined, or multi-threaded instruction execution. Each processor may be implemented as one or more general-purpose processors, ASICs, FPGAs, GPUs, TPUs, digital signal processors (DSPs), or other suitable electronic data processing components structured to execute instructions provided by memory. The one or more processors may take the form of a single core processor, multi-core processor (e.g., a dual core processor, triple core processor, or quad core processor), microprocessor, etc. In some implementations, the one or more processors may be external to the apparatus, for example, the one or more processors may be a remote processor (e.g., a cloud-based processor). Alternatively or additionally, the one or more processors may be internal or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the implementations might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile or non-volatile memories), etc. In some implementations, the non-volatile media may take the form of ROM, flash memory (e.g., flash memory such as NAND, 3D NAND, NOR, 3D NOR), EEPROM, MRAM, magnetic storage, hard discs, optical discs, etc. In other implementations, the volatile storage media may take the form of RAM, TRAM, ZRAM, etc. Combinations of the above are also included within the scope of machine-readable media. In this regard, machine-executable instructions comprise, for example, instructions and data which cause a general-purpose computer, special-purpose computer, or special-purpose processing machine to perform a certain function or group of functions. Each respective memory device may be operable to maintain or otherwise store information relating to the operations performed by one or more associated circuits, including processor instructions and related data (e.g., database components, object code components, script components), in accordance with the example implementations described herein.

It should also be noted that the term “input devices,” as described herein, may include any type of input device, including, but not limited to, a keyboard, a keypad, a mouse, a joystick, or other input devices performing a similar function. Comparatively, the term “output device,” as described herein, may include any type of output device, including, but not limited to, a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative implementations. Accordingly, all such modifications are intended to be included within the scope of the present disclosure as defined in the appended claims. Such variations will depend on the machine-readable media and hardware systems chosen and on the designer's choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps, and decision steps.

While this specification contains many specific implementation details, these should not be construed as limitations on the scope of any inventions or of what may be claimed but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can, in some cases, be excised from the combination, and the claimed combination may be directed to a sub-combination or variation of a sub-combination.

In certain circumstances, multitasking and parallel processing may be advantageous. Moreover, the separation of various system components in the implementations described above should not be understood as requiring such separation in all implementations, and it should be understood that the described program components and systems can generally be integrated together into a single software product or packaged into multiple software products.

Having now described some illustrative implementations and implementations, it is apparent that the foregoing is illustrative and not limiting, having been presented by way of example. In particular, although many of the examples presented herein involve specific combinations of method acts or system elements, those acts, and those elements may be combined in other ways to accomplish the same objectives. Acts, elements, and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein is meant to encompass the items listed thereafter, equivalents thereof, and additional items, as well as alternate implementations consisting of the items listed thereafter exclusively. In one implementation, the systems and methods described herein consist of one, each combination of more than one or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementations,” “one implementation,” or the like are not necessarily mutually exclusive and are intended to indicate that a particular feature, structure, or characteristic described in connection with the implementation may be included in at least one implementation. Such terms, as used herein, are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence has any limiting effect on the scope of any claim elements.

The foregoing description of implementations has been presented for purposes of illustration and description. It is not intended to be exhaustive or to limit the disclosure to the precise form disclosed, and modifications and variations are possible in light of the above teachings or may be acquired from this disclosure. The implementations were chosen and described in order to explain the principals of the disclosure and its practical application to enable one skilled in the art to utilize the various implementations and with various modifications as are suited to the particular use contemplated. Other substitutions, modifications, changes, and omissions may be made in the design, operating conditions, and implementation of the implementations without departing from the scope of the present disclosure as expressed in the appended claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for presenting a virtual task-based environment for a user, the method comprising:
receiving, by at least one processor, background information about a user having a disability or learning style;
maintaining, by the at least one processor, an internal attribute representation for the user in a data structure configured to map user behaviors and task performance to a plurality of skill dimensions;
mapping, by the at least one processor, a success matrix comprising mappings from disability-related attributes or observed behaviors to corresponding accommodation strategies, task-level supports, and success criteria for one or more of the plurality of skill dimensions;
generating, by the at least one processor using a machine learning model, at least one task based on the background information about the user, wherein the at least one task is configured for completion in the virtual task-based environment by the user based in-part on a disability or learning style of the user;
presenting, by the at least one processor, a virtual workspace configured to simulate a work environment by containing the at least one task for completion and containing buttons configured to receive an input from the user;
executing, by the at least one processor using at least one input associated with the at least one task, an artificial intelligence-based interactive component comprising a transformer model trained on internship data and a plurality of disabilities and learning styles to generate and display a natural-language guidance message comprising at least one of task customized based on the disability or learning style of the user;
responsive to initiation or completion of at least one task presented on the virtual workspace, executing, by the at least one processor, an artificial intelligence model receiving information about the initiation or completion of the task comprising at least one of a task initiation time, a task completion time, or a task submission status, and to compare the information to an expectation and other users to predict performance assessment data;
updating, by the at least one processor, the data structure based on the information about the initiation or completion of the at least one task, including assigning one or more scores or indicators for skills associated with the at least one task;
selecting, by the at least one processor based on the updated data structure, the success matrix, and the performance assessment data, one or more personalized coaching prompts or accommodation recommendations for the user for subsequent tasks in the virtual task-based environment; and
generating and transmitting, by the at least one processor, a report of the initiation or completion of the at least one task to a remote computer, wherein the report dynamically adjusts to performance trends of other users and further comprises one or more skill indicators derived from the data structure and at least one accommodation or strategy derived from the success matrix.

2. The computer-implemented method of claim 1, wherein the data structure comprises a multi-dimensional vector representation of the user's skills, each dimension corresponding to at least one of applied academic skills, critical thinking skills, interpersonal skills, personal qualities, resource management, information use, communication skills, systems thinking, or technology use.

3. The computer-implemented method of claim 1, wherein updating the data structure comprises mapping individual user interactions within the virtual workspace to one or more skill dimensions using a predefined ruleset or machine-learned model.

4. The computer-implemented method of claim 1, wherein the success matrix comprises a plurality of entries, each entry associating at least one of a disability label or pattern of observed behaviors with at least one of task-level accommodations, workflow modifications, coaching strategies or corresponding success criteria for at least one skill dimension.

5. The computer-implemented method of claim 1, wherein selecting one or more personalized coaching prompts based on the updated data structure and the success matrix comprises identifying at least one skill dimension below a proficiency threshold.

6. The computer-implemented method of claim 1, wherein the report further comprises legally compliant transition-planning evidence by tagging skill indicators with at least one of an Individuals with Disabilities Education Act (IDEA) transition domain and a Perkins skills framework category.

7. The computer-implemented method of claim 1, wherein generating at least one task further comprises modifying task parameters based on the success matrix to incorporate one or more accommodations selected for the user, including at least one of extended time, altered presentation modality, simplified instructions, or assistive technology prompts.

8. A system for presenting a virtual task-based environment for a user, the system comprising at least one processor configured to:
receive background information about a user having a disability or learning style;
maintain an internal attribute representation for the user in a data structure configured to map user behaviors and task performance to a plurality of skill dimensions;
map a success matrix comprising mappings from disability-related attributes or observed behaviors to corresponding accommodation strategies, task-level supports, and success criteria for one or more of the plurality of skill dimensions;
generate, using a machine learning model, at least one task based on the background information about the user, wherein the at least one task is configured for completion in the virtual task-based environment by the user based in-part on a disability or learning style of the user;
present a virtual workspace configured to simulate a work environment by containing the at least one task for completion and containing buttons configured to receive an input from the user;
execute, using at least one input associated with the at least one task, an artificial intelligence-based interactive component comprising a transformer model trained on internship data and a plurality of disabilities and learning styles to generate and display a natural-language guidance message comprising at least one of task customized based on the disability or learning style of the user;
responsive to initiation or completion of at least one task presented on the virtual workspace, execute an artificial intelligence model receiving information about the initiation or completion of the task comprising at least one of a task initiation time, a task completion time, or a task submission status, and to compare the information to an expectation and other users to predict performance assessment data;
update the data structure based on the information about the initiation or completion of the at least one task, including assigning one or more scores or indicators for skills associated with the at least one task;
select, based on the updated data structure, the success matrix, and the performance assessment data, one or more personalized coaching prompts or accommodation recommendations for the user for subsequent tasks in the virtual task-based environment; and
generate and transmit a report of the initiation or completion of the at least one task to a remote computer, wherein the report dynamically adjusts to performance trends of other users and further comprises one or more skill indicators derived from the data structure and at least one accommodation or strategy derived from the success matrix.

9. The system of claim 8, wherein the data structure comprises a multi-dimensional vector representation of the user's skills, each dimension corresponding to at least one of applied academic skills, critical thinking skills, interpersonal skills, personal qualities, resource management, information use, communication skills, systems thinking, or technology use.

10. The system of claim 8, wherein updating the data structure comprises mapping individual user interactions within the virtual workspace to one or more skill dimensions using a predefined ruleset or machine-learned model.

11. The system of claim 8, wherein the success matrix comprises a plurality of entries, each entry associating at least one of a disability label or pattern of observed behaviors with at least one of task-level accommodations, workflow modifications, coaching strategies or corresponding success criteria for at least one skill dimension.

12. The system of claim 8, wherein selecting one or more personalized coaching prompts based on the updated data structure and the success matrix comprises identifying at least one skill dimension below a proficiency threshold.

13. The system of claim 8, wherein the report further comprises legally compliant transition-planning evidence by tagging skill indicators with at least one of an Individuals with Disabilities Education Act (IDEA) transition domain and a Perkins skills framework category.

14. The system of claim 8, wherein generating at least one task further comprises modifying task parameters based on the success matrix to incorporate one or more accommodations selected for the user, including at least one of extended time, altered presentation modality, simplified instructions, or assistive technology prompts.

15. A system for presenting a virtual task-based environment for a user, the system comprising a non-transitory computer readable medium having at least one instructions that when executed causes at least one processor to:
receive background information about a user having a disability or learning style;
maintain an internal attribute representation for the user in a data structure configured to map user behaviors and task performance to a plurality of skill dimensions;
map a success matrix comprising mappings from disability-related attributes or observed behaviors to corresponding accommodation strategies, task-level supports, and success criteria for one or more of the plurality of skill dimensions;
generate, using a machine learning model, at least one task based on the background information about the user, wherein the at least one task is configured for completion in the virtual task-based environment by the user based in-part on a disability or learning style of the user;
present a virtual workspace configured to simulate a work environment by containing the at least one task for completion and containing buttons configured to receive an input from the user;
execute, using at least one input associated with the at least one task, an artificial intelligence-based interactive component comprising a transformer model trained on internship data and a plurality of disabilities and learning styles to generate and display a natural-language guidance message comprising at least one of task customized based on the disability or learning style of the user;
responsive to initiation or completion of at least one task presented on the virtual workspace, execute an artificial intelligence model receiving information about the initiation or completion of the task comprising at least one of a task initiation time, a task completion time, or a task submission status, and to compare the information to an expectation and other users to predict performance assessment data;
update the data structure based on the information about the initiation or completion of the at least one task, including assigning one or more scores or indicators for skills associated with the at least one task;
select, based on the updated data structure, the success matrix, and the performance assessment data, one or more personalized coaching prompts or accommodation recommendations for the user for subsequent tasks in the virtual task-based environment; and
generate and transmit a report of the initiation or completion of the at least one task to a remote computer, wherein the report dynamically adjusts to performance trends of other users and further comprises one or more skill indicators derived from the data structure and at least one accommodation or strategy derived from the success matrix.

16. The system of claim 15, wherein the data structure comprises a multi-dimensional vector representation of the user's skills, each dimension corresponding to at least one of applied academic skills, critical thinking skills, interpersonal skills, personal qualities, resource management, information use, communication skills, systems thinking, or technology use.

17. The system of claim 15, wherein updating the data structure comprises mapping individual user interactions within the virtual workspace to one or more skill dimensions using a predefined ruleset or machine-learned model.

18. The system of claim 15, wherein the success matrix comprises a plurality of entries, each entry associating at least one of a disability label or pattern of observed behaviors with at least one of task-level accommodations, workflow modifications, coaching strategies or corresponding success criteria for at least one skill dimension.

19. The system of claim 15, wherein selecting one or more personalized coaching prompts based on the updated data structure and the success matrix comprises identifying at least one skill dimension below a proficiency threshold.

20. The system of claim 15, wherein the report further comprises legally compliant transition-planning evidence by tagging skill indicators with at least one of an Individuals with Disabilities Education Act (IDEA) transition domain and a Perkins skills framework category.
